(19) United States
(12) Patent Application Publication
(10) Pub. No.: US 2026/0359675 A1
(43) Pub. Date: Nov. 12, 2026

(54) SYSTEMS AND METHODS FOR FOCUSED QUESTION ANSWERING IN CONTACT CENTER ANALYSIS

(71) Applicant: Verint Americas, Inc., Alpharetta, GA (US)

(72) Inventors: Dvir Cohen, Tel Aviv (IL); Samuel Londner, Tel Aviv (IL); Eran Sela, Kadima (IL); Karni Gilon, Herzliya (IL)

(21) Appl. No.: 19/203,970

(22) Filed: May 9, 2025

(51) Int. Cl. G06N 5/04

(52) U.S. Cl. CPC G06N 5/04

(57) ABSTRACT

An example system for data processing includes a computing device and a computer-readable medium with computer-executable instructions stored thereon that when executed by the computing device cause the computing device to: receive, by a computing device, a plurality of text interactions and a query from a user, select, by a first large language model, a selected workflow from a plurality of workflows based on the query, generate, by a second large language model a workflow prompt corresponding to the selected workflow, input the workflow prompt and the plurality of text interactions into a third large language model to obtain a corpus of results, post-process the corpus of results to obtain a result to the query, and present, by a user interface of the computing device, the result to the user.

### BACKGROUND

Data analysis can involve analyzing trends, patterns, anomalies, and other features in large volumes of data. One example context where data analysis can be applied is to contact center data. In a contact center or other customer service system, hundreds or thousands of human agents can each generate thousands of words of text per day. The text can be natural language in the form of written emails, chat messages, and/or transcribed phone calls.

Analyzing large amounts of text data can be challenging. For example, analyzing many call transcripts can be a tedious and time-consuming task. Automated methods like keyword searching or rules-based techniques can fail when the text data includes variations in diction and/or syntax that can be difficult to predict. Thus, existing approaches fail to provide automated methods for applying data analysis to large amounts of text data.

### SUMMARY

Systems and methods for data analysis are provided. A user interface is provided that allows an analyst to input natural language queries for analysis by one or more large language models. The one or more large language models can be configured to route the query to a workflow, generate a prompt configured for the workflow, run the workflow using the prompt, output results, and post-process the results for display by the user interface.

In some aspects, implementations of the present disclosure include a method including: receiving, by a computing device, a plurality of text interactions and a query from a user; selecting, by a first large language model, a selected workflow from a plurality of workflows based on the query generating, by a second large language model a workflow prompt corresponding to the selected workflow; inputting the workflow prompt and the plurality of text interactions into a third large language model to obtain a corpus of results; post-processing the corpus of results to obtain a result to the query; and presenting, by the computing device, the result to the user.

In some aspects, implementations of the present disclosure include a method wherein each text interaction of the plurality of text interactions is separately input into the third large language model.

In some aspects, implementations of the present disclosure include a method, wherein the plurality of text interactions are input into the third large language model in parallel.

In some aspects, implementations of the present disclosure include a method, wherein the third large language model is a smaller model than the first large language model or the second language model.

In some aspects, implementations of the present disclosure include a method, wherein the selected workflow includes a counting workflow, and wherein the third large language model is configured to determine a presence or absence of a feature selected by the query in each of the plurality of text interactions.

In some aspects, implementations of the present disclosure include a method, wherein the selected workflow includes an aggregation and statistical analysis workflow, and wherein the aggregation and statistical analysis workflow includes aggregating the corpus of results to a smaller number of representative results by a fourth large language model, and classifying each of the plurality of text interactions to output a plurality of relevant results based on the query by a fifth large language model or by an embedding model.

In some aspects, implementations of the present disclosure include a method, wherein the selected workflow includes an indexing workflow, and wherein the third large language model is configured to determine a feature of each of the plurality of text interactions based on the query.

In some aspects, implementations of the present disclosure include a method, wherein post-processing the corpus of results includes applying a classifier to the corpus of results or augmenting the corpus of results with grounding data.

In some aspects, implementations of the present disclosure include a method, further including generating grounding data by pattern matching a quote from the plurality of text with the corpus of results.

In some aspects, implementations of the present disclosure include a method, further including: receiving, by a computing device, a query history, wherein the query history includes a plurality of queries and a plurality of responses corresponding to the plurality of queries; and determining by the first large language model, that the query matches one of the plurality of queries; and outputting the corresponding response from the plurality of responses.

In some aspects, implementations of the present disclosure include a method, wherein the selected workflow includes an open-ended workflow, and wherein the third large language model is configured to provide open-ended based on each of the plurality of text interactions based on the query.

In some aspects, implementations of the present disclosure include a system including: a computing device; and a computer-readable medium with computer-executable instructions stored thereon that when executed by the computing device cause the computing device to: receive, by a computing device, a plurality of text interactions and a query from a user; select, by a first large language model, a selected workflow from a plurality of workflows based on the query generate, by a second large language model a workflow prompt corresponding to the selected workflow; input the workflow prompt and the plurality of text interactions into a third large language model to obtain a corpus of results; post-process the corpus of results to obtain a result to the query; and present, by a user interface of the computing device, the result to the user.

In some aspects, implementations of the present disclosure include a system, further including computer-executable instructions that when executed by the computing device cause the computing device to: separately input each text interaction of the plurality of text interactions into the third large language model.

In some aspects, implementations of the present disclosure include a system, further including computer-executable instructions that when executed by the computing device cause the computing device to: input the plurality of text interactions into the third large language model in parallel.

In some aspects, implementations of the present disclosure include a system, wherein the third large language model is a smaller model than the first large language model or the second language model.

In some aspects, implementations of the present disclosure include a system, wherein the selected workflow includes a counting workflow, and wherein the third large language model is configured to determine a presence or absence of a feature selected by the query in each of the plurality of text interactions.

In some aspects, implementations of the present disclosure include a system, wherein the selected workflow includes a statistical analysis workflow, and wherein the third large language model is configured to classify each of the plurality of text interactions based on the query.

In some aspects, implementations of the present disclosure include a system, wherein the selected workflow includes an aggregation and statistical analysis workflow, and wherein the aggregation and statistical analysis workflow includes aggregating the corpus of results to a smaller number of representative results by a fourth large language model, and classifying each of the plurality of text interactions to output a plurality of relevant results based on the query by a fifth large language model or by an embedding model.

In some aspects, implementations of the present disclosure include a system, wherein the selected workflow includes an indexing workflow, and wherein the third large language model is configured to determine a feature of each of the plurality of text interactions based on the query.

In some aspects, implementations of the present disclosure include a system, further including computer-executable instructions that when executed by the computing device cause the computing device to: augment the corpus of results with grounding data or apply a classifier to the corpus of results..

In some aspects, implementations of the present disclosure include a system, further including computer-executable instructions that when executed by the computing device cause the computing device to: generate the grounding data by pattern matching a quote from the plurality of text with the corpus of results.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The foregoing summary, as well as the following detailed description of illustrative embodiments, is better understood when read in conjunction with the appended drawings. For the purpose of illustrating the disclosed embodiments, there is shown in the drawings example constructions of the embodiments; however, the possible embodiments are not limited to the specific methods and instrumentalities disclosed for automated quality management. In the drawings:

FIG. 1 illustrates an example environment for performing data analysis to evaluate one or more queries, according to an example embodiment of the present disclosure.

FIG. 2 illustrates an example environment for performing data analysis using one or more workflows, to evaluate one or more queries, according to an example embodiment of the present disclosure.

FIG. 3A illustrates an example environment for a statistical workflow that can be used in the environment of FIG. 2.

FIG. 3B illustrates an example environment for an open-ended workflow that can be used in the environment of FIG. 2.

FIG. 3C illustrates an example environment for a counting workflow that can be used in the environment of FIG. 2.

FIG. 3D illustrates an example environment for an indexing workflow that can be used in the environment of FIG. 2.

FIG. 4 illustrates an example method according to embodiments of the present disclosure.

FIG. 5 illustrates an example computing environment.

### DETAILED DESCRIPTION

The systems and methods include data pre-processing, prompt augmentation, and post-processing techniques that improve the efficiency and accuracy of data analysis using large language models. Large language models (LLMs) are machine learning models trained on large-scale corpora of natural language text. LLMs can be defined by lists of numerical parameters that include weights (e.g., scaling the input value of nodes) and biases (e.g., constant shifts). As used herein, when LLMs are referred to as being “larger” or “smaller” than one another, the “larger” LLM has more parameters, and the “smaller” LLM has fewer parameters. The number of parameters in the LLM can be directly proportional to both the training cost of the LLM and the cost to use the LLM for text creation and/or analysis. However, larger LLMs can be more reliable and accurate than smaller LLMs.

LLMs can both generate and/or analyze natural language by predicting sequences of text (e.g., sequences of “tokens” that represent units of text). Because LLMs predict sequences of text based on training data, when applied to specific problems, LLMs can output text that looks correct but is factually wrong.

LLMs also have limits on the amount of data that can be input (referred to as the “context window” of the LLM). The quality of LLM responses can also be degraded by long input sizes, even within the context window of the LLM. And, moreover, the cost and speed of the LLM can be proportional to the input size. In short, large scale text data analysis by LLMs is limited by both the factual inaccuracies in LLM outputs and the inefficiency of using larger LLMs for data analysis across large datasets. These limits on LLMs prevent LLMs from being routinely used for many tasks performed by data analysts.

Embodiments of the present disclosure overcome these and other challenges in the art by improving systems, methods, and devices for data analytics with LLMs. An example implementation includes a system with multiple LLM systems. Smaller LLMs are used for high-volume tasks in a workflow, while larger LLMs are used to perform specific tasks that pre- and post-process inputs to the smaller LLM. For example, user queries are processed by a larger LLM to accurately determine the correct workflow for the query, and a larger LLM can also be used to determine a prompt for the workflow. The workflow can then execute the prompt by one or more smaller LLMs in parallel, increasing the speed of execution and reducing the cost. The results can then be post-processed by machine learning classifiers, natural language processing, or additional LLMs to improve the accuracy of the results from the LLMs (for example, by grounding the results in real text data). Thus, embodiments of the present disclosure improve the speed and accuracy of systems for data analysis by incorporating both specific combinations of large language model systems and other components.

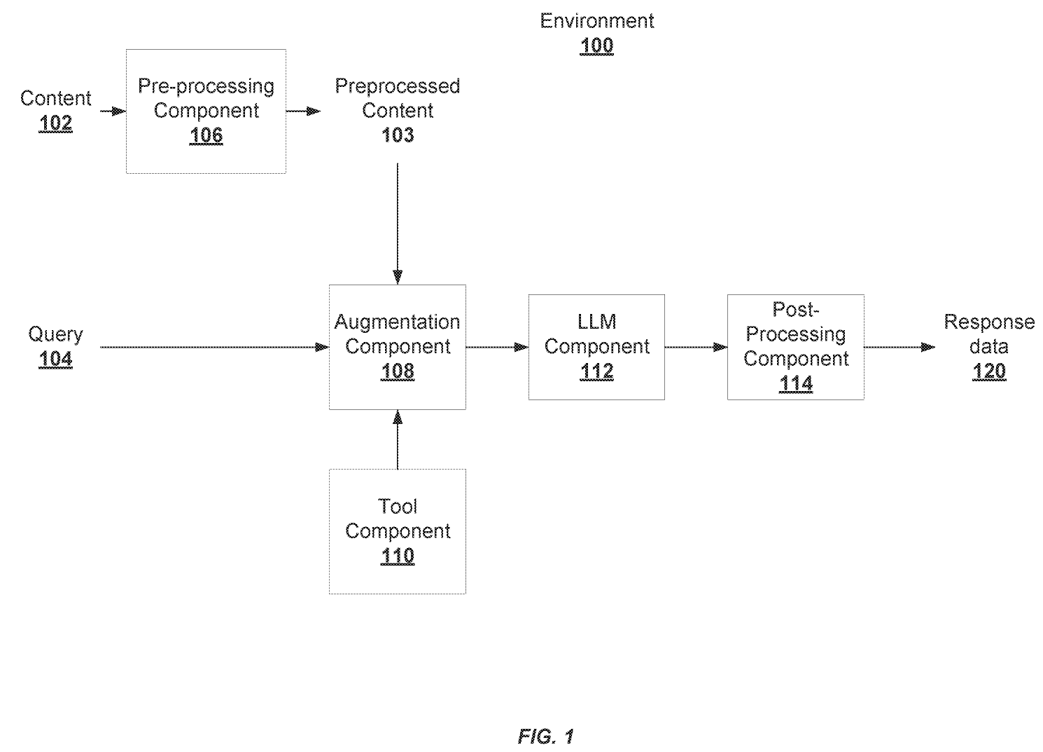

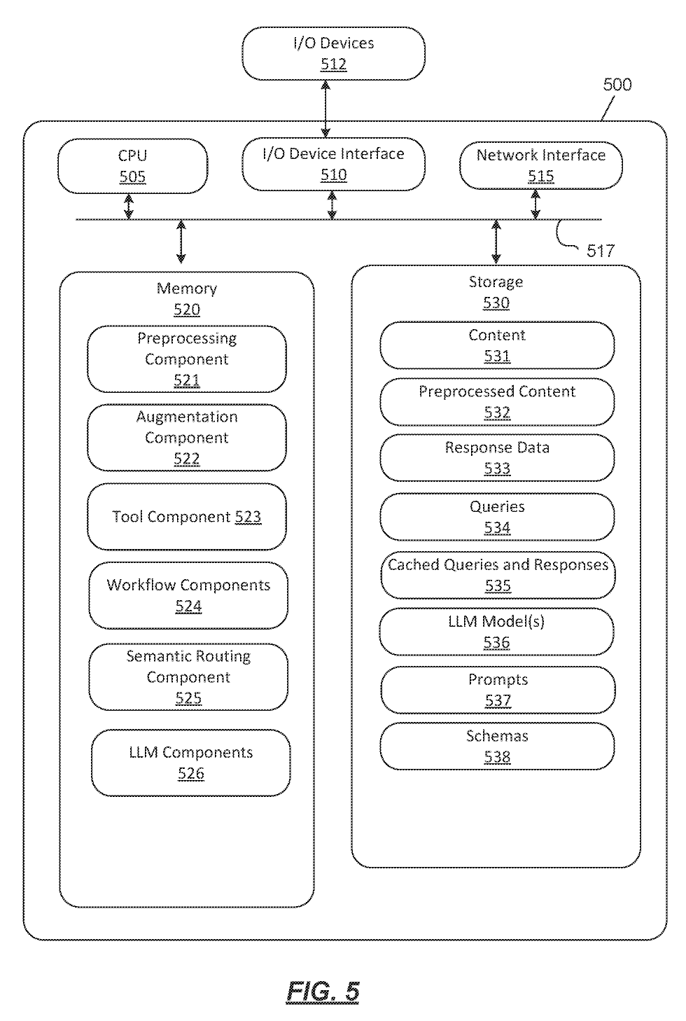

FIG. 1 is an illustration of an example environment 100 for data analysis by evaluating one or more queries. The environment 100 can be implemented by the computing system 500 shown in FIG. 5.

The environment 100 is configured to receive content 102 and a query 104. The content 102 can include any number of text interactions stored in memory. Non-limiting examples of text interactions include: call transcripts, chat logs, emails, and email threads. The content 102 can optionally include metadata associated with the text interactions. Examples of metadata include interaction-level metadata (e.g., the time length of each interaction, or if the interaction is a transfer interaction). The metadata can be processed in the workflows described herein as part of the content 102 and preprocessed content 103 described below. For example, metadata can be used by workflows to answer queries such as “Which topics do the most lengthy interactions deal with?” and “In which cases are interactions transferred?”. Another example of metadata is a “tag” which can optionally be included in the content 102 or added by a pre-processing component 106 described below. For example, if the interactions are tagged based on categories, the tags can be used to generate suggested queries and/or as inputs to the workflows themselves.

Content 102 can be input into the preprocessing component 106. The pre-processing component 106 can preprocess the content 102 by removing information in the content 102 that is not part of the text interaction (e.g., email headers and signatures). Alternatively or additionally, preprocessing can include augmenting the text interactions with metadata (e.g., interaction/message IDs, and speaker/sender IDs). Preprocessing can improve the functioning of large language models by reducing the length of the text input into them, which increases processing speed, reduces cost, and increases accuracy. Additionally, preprocessing can improve the functioning of LLMs by adding metadata to the text data to allow the LLM to identify speakers in a conversation, or a timeline of events, for example. The pre-processing component can output preprocessed content 103.

An augmentation component 108 can be used to construct an input to the LLM that optimizes the performance of an LLM for a user query 104. The augmentation component 108 can receive the preprocessed content 103 and the query 104 to construct a prompt to be input into the large language model component 112.

Optionally, the augmentation component 108 can be configured to receive an input from a tool component 110. The tool component 110 can provide one or more tools to the augmentation component 108. Optionally, the tools can include default instructions and formats that augment the query 104 and the preprocessed content 103 by providing context to the large language model component 112. For example, the tool component 110 can include schemas (e.g., implemented using JSON) configured to control the large language model component 112 and/or example outputs for the large language model component 112 (e.g., model responses or allowed values of responses).

The augmentation component 108 can optionally augment the processed content 103 with the tools from the tool component 110 and the query 104. The preprocessed content 103, tools, and query 104 can then be a single input to the large language model component 112. However, this can require larger LLMs to perform accurately, resulting in increased latency and cost. Additionally, some LLMs may have context windows that are smaller than the size of the preprocessed content 103. These limitations can make this approach less desirable for some LLMs and some preprocessed content, although the present disclosure contemplates using LLMs with very large context windows (e.g., greater than ten million tokens) in some embodiments of the present disclosure.

In some embodiments, the augmentation component 108 can split the preprocessed content 103 into individual text interactions or groups of text interactions. For example, each text interaction can correspond to a single call, single email thread, or single chat session. Alternatively or additionally, the text interactions can be batched into subsets of the entire preprocessed content, so that each text interaction includes a predefined amount of text or tokens. The augmentation component 108 can then combine each individual text interactions or each subset of preprocessed content with the tools and the query 104 before input into the large language model component 112.

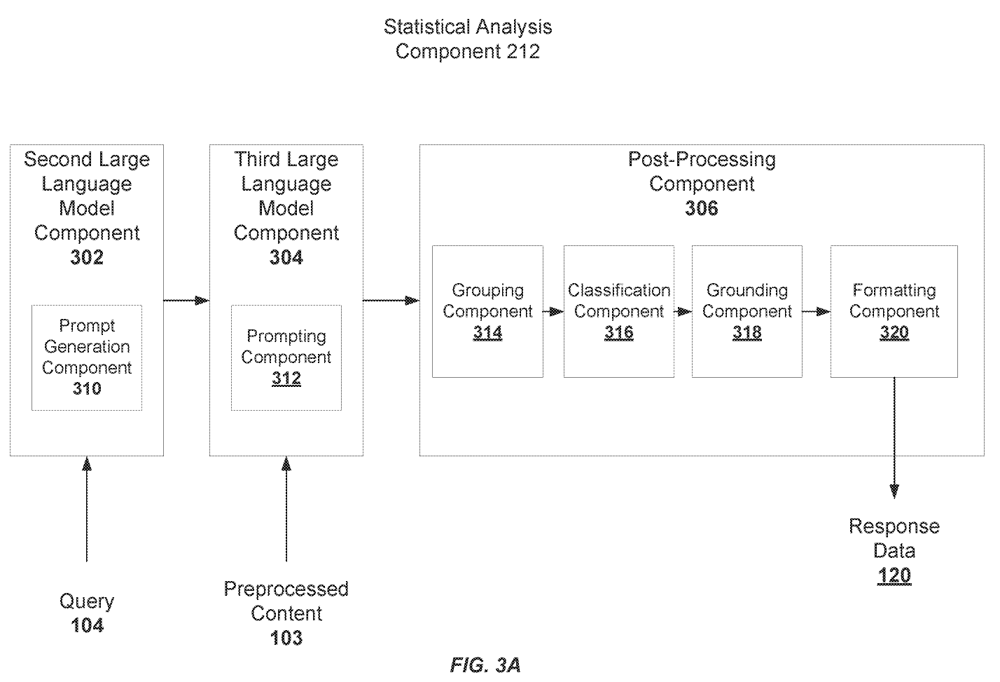

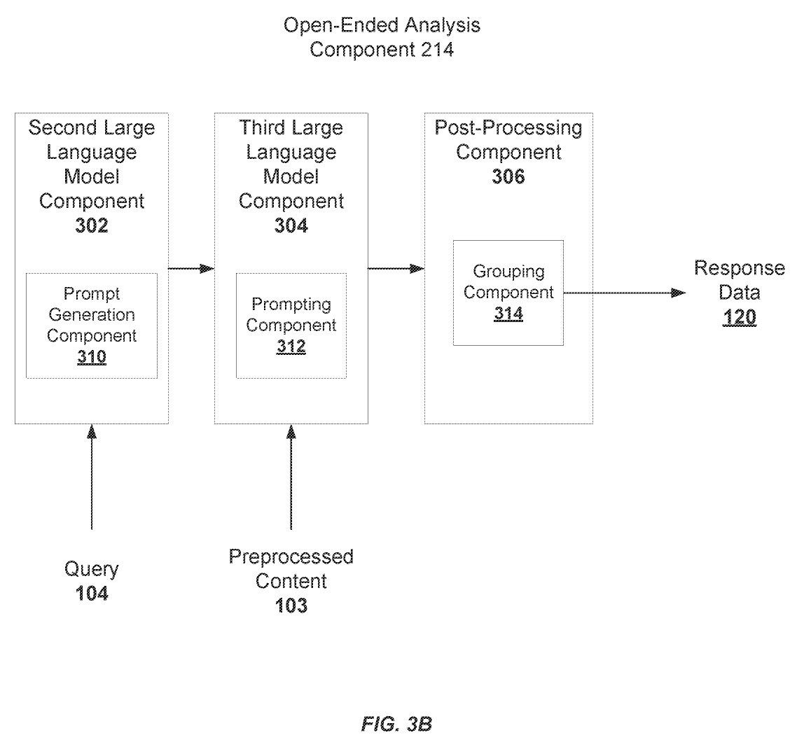

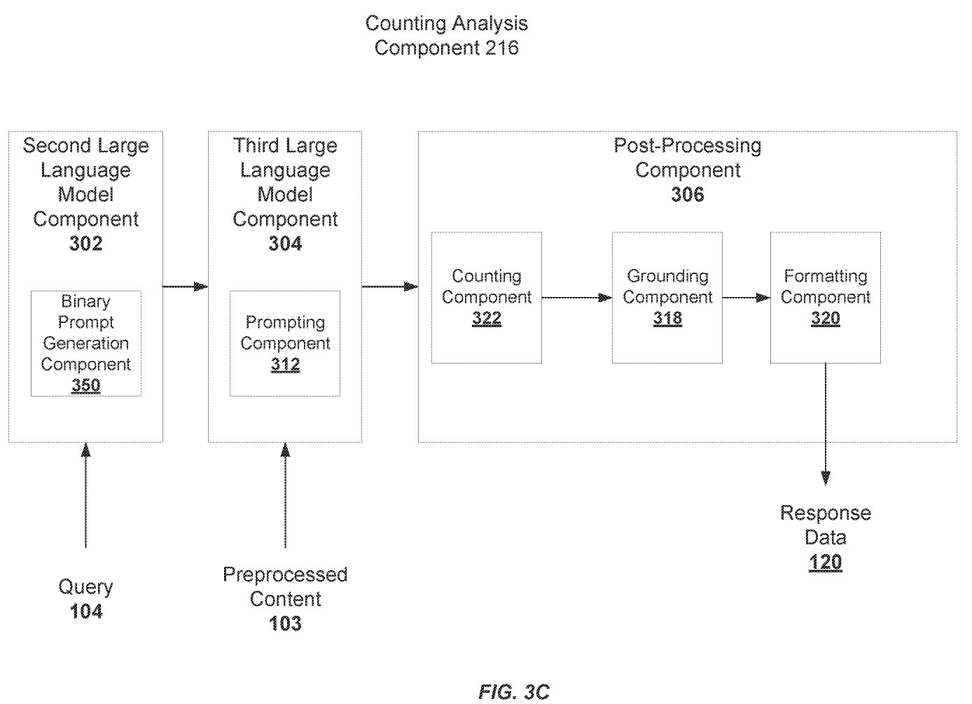

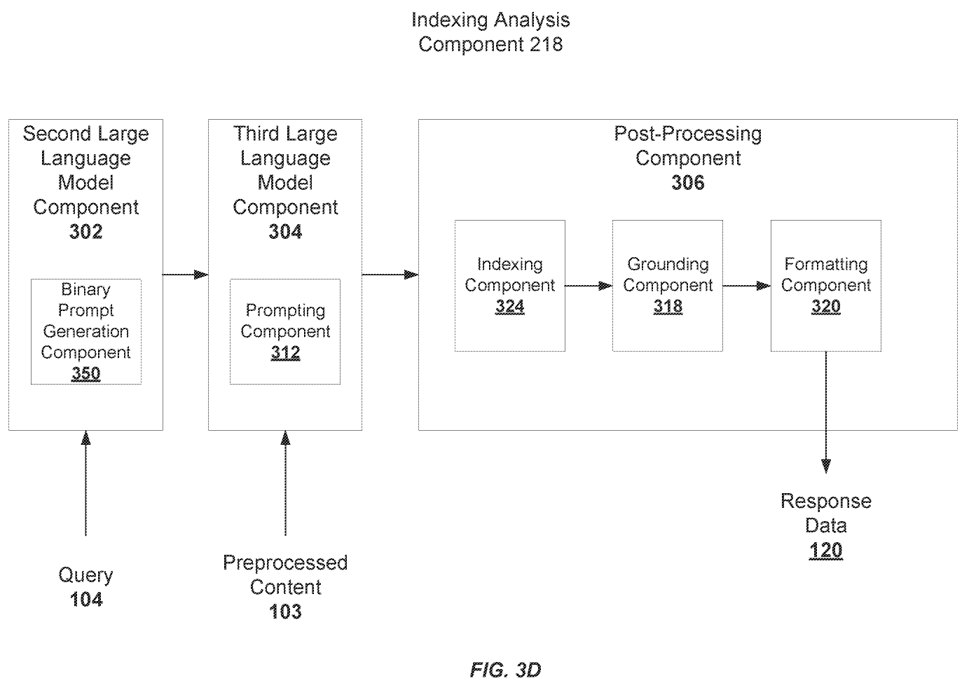

The large language model component 112 can include one or more LLMs configured in inference mode to receive prompts and generate text outputs in response to the prompts. The large language model component 112 can optionally be a smaller model or a larger model. The large language model component 112 can output the answer to the prompt to a post-processing component 114. The post-processing component 114 can format the output. In embodiments where multiple prompts are input to the large language model component 112 by the augmentation component 108, the post-processing component 114 can be configured to combine the results for each prompt into a single result. Optionally, the environment 100 can further include a grounding component (not shown). Additional description of grounding components is provided with respect to FIGS. 3A and 3C herein.

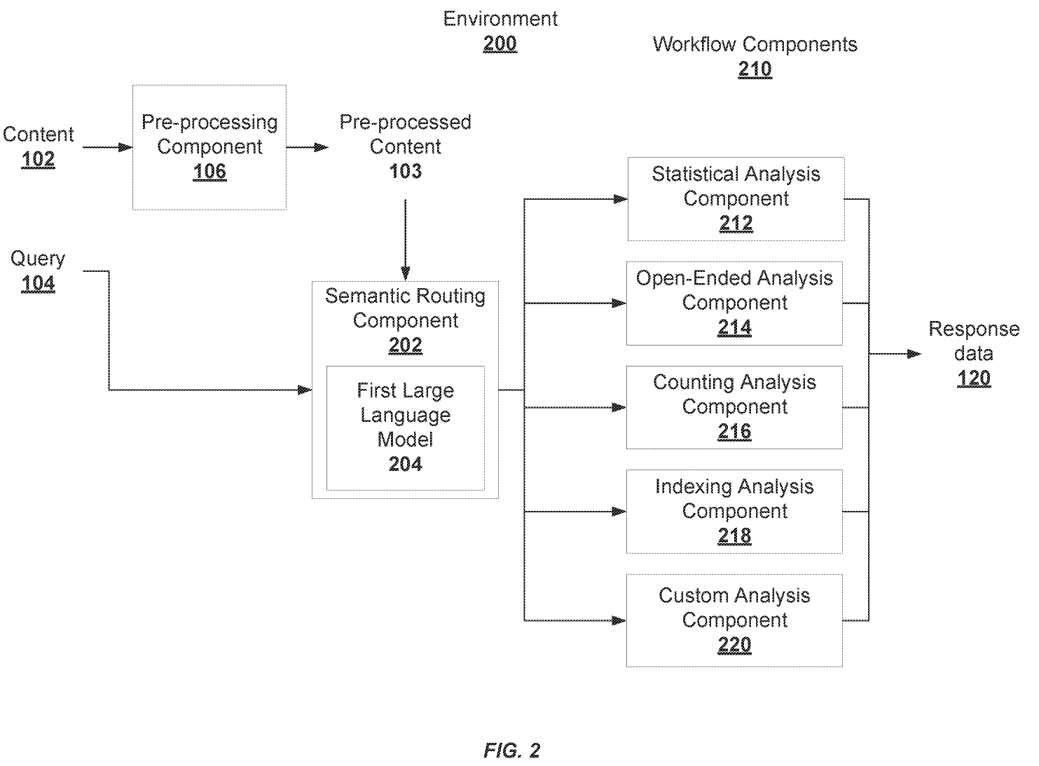

FIG. 2 is an illustration of an example environment 200 for data analysis by evaluating one or more queries by one or more workflows components 210. The environment 200 can be implemented by the computing system 500 shown in FIG. 5. The environment 200 can include the content 102, query 104, and preprocessing component 106 described with reference to FIG. 1.

The environment 200 of FIG. 2 includes a semantic routing component 202. The semantic routing component 202 can be implemented using a first large language model 204 to evaluate the query 104 and/or the preprocessed content 103 and determine which of the workflow components 210 can best answer the query. For example, if the query is “count the number of conversations where a participant is dissatisfied” then a counting analysis component 216 can be selected by the semantic routing component. As another example, if the query is “find the time in each call where the user provides feedback” then an indexing analysis component 218 can be selected. As yet another example, if the query is “identify ways to improve customer service” then an open-ended analysis component 214 can be selected As still another example, if the query is “identify reasons why users call” then the statistical analysis component 212 can be selected. Optionally, the semantic routing component 202 can be a larger LLM than the second LLM.

As described in more detail with reference to FIGS. 3A-3D, each of the workflow components 210 can be configured to generate a prompt, apply that prompt to an input, and post-process the result. Optionally, the environment 200 can be configured to allow users to define any number of custom analysis component(s) 220. Defining custom analysis components 220 can include selecting large language model(s) to implement the custom analysis components, defining prompts used for the large language model(s) and/or defining post-processing operations to be performed on the output of the large language model(s). For example, the user can define a “tagging” workflow that groups and classifies text interactions from the preprocessed content to apply metadata tags to the text interactions.

FIGS. 3A-3D illustrate examples of workflow components 210. Each of the workflow components 210 can use a second large language model component 302 and a third large language model component 304 to improve the processing of data by the workflow components 210. The second large language model component 302 can be larger than the third large language model component 304, so that the outputs of the second large language model component 302 can be more expensive, but also higher quality.

The systems and methods disclosed herein can improve the quality of text analysis, and reduce the cost of the text analysis, by using the larger second large language model component 302 to generate a high-quality output including a prompt for a smaller third large language model component 304. The smaller third large language model component 304 then applies the prompt across the preprocessed content. The smaller third large language model component 304 can be faster, cheaper, and/or more efficient to run. Thus, dividing prompt generation and applying the prompt to the preprocessed content between two large language models allows for the larger, slower, and/or more expensive model to be used for generating the prompt, while the preprocessed content 103 can be only input into the smaller third large language model. Embodiments of the present disclosure therefore improve the efficiency, accuracy, and/or speed of data analysis using large language models.

Optionally, the third large language model component 304 can include more than one instance of the third large language model, allowing many prompts to be run in parallel across different parts of the preprocessed content 103. Because the third large language model component 304 can be a smaller large language model, it can be suitable for running in parallel (e.g., due to lower memory requirements and fewer parameters).

FIG. 3A illustrates an example statistical analysis component 212. The statistical analysis component 212 is configured to convert information from natural language text (e.g., the preprocessed content 103) into a statistical analysis.

The statistical analysis component 212 can be implemented using a second large language model component 302, a third large language model component 304, and a post-processing component 306. The second large language model component 302 can include a prompt generation component 310 that is configured to transform the query 104 into a suitable prompt for the preprocessed content 103. For example, the query 104 can be “why do customers call.”

The second large language model component 302 can output the prompt to the third large language model component 304, which can be configured to apply the prompt to the preprocessed content by operating the large language model of the third large language model component 304 in inference mode.

The prompting component 312 of the third large language model component 304 can apply the prompt generated by the second large language model component 302 to the preprocessed content. As used herein, “applying” the prompt can refer to appending the prompt to a beginning or end of at least a portion of the preprocessed content. The preprocessed content and prompt are then input into the large language model of the third large language model component 304.

In some embodiments, the prompting component 312 is configured to iteratively process the preprocessed content. For example, the prompting component 312 can split the preprocessed content 103 into sections that are smaller than the entirety of the preprocessed content 103 (e.g., one or more conversations and one or more transactions). For example, the prompting component 312 can select the sections of the preprocessed content that fit within the context window of the third large language model component 304.

Alternatively or additionally, the prompting component 312 can be configured to process the preprocessed content in parallel. The third large language model component 304 can include any number of large language models (e.g., many different computing devices each including the same large language model configured in inference mode). Each section of preprocessed content with prompt applied can be separately routed to one of many large language models, so that the entirety of the preprocessed content is processed in parallel by many large language models. Embodiments of the present disclosure including parallel processing can improve latency because the speed of responses by LLMs can be based on the size of the input and the length of the output, so many shorter inputs and shorter outputs can be done simultaneously in less time than it would take for the LLM to process a single larger input into a single larger output.

As yet another example, combinations of serial and parallel processing are possible. For example, the preprocessed content 103 may be so large that even when split into sections the preprocessed content would not fit in the context windows of all the large language models operating in parallel. Therefore in some embodiments with parallel processing multiple serial steps may be required to fully process the preprocessed content.

The output of the third large language model component 304 can be input into the post-processing component 306. Optionally, when preprocessed content is split into sections, the post-processing component 306 can be configured to collate the third large language model component’s responses to each section of the preprocessed content.

Still with reference to FIG. 3A, the present disclosure contemplates that the post-processing component 306 can include components and different functionalities. For example, the post-processing component 306 can be configured based on the type of workflow component. For example, because FIG. 3A illustrates a statistical analysis component 212, the post-processing component can include a grouping component 314, a classification component 316, a grounding component 318, and a formatting component 320.

The grouping component 314 is configured to generate a set of groupings based on the outputs of the third large language model component 304. Optionally, the outputs of the third large language model component 304 can be referred to herein as “extracted facts.” For example, the grouping component 314 can optionally include a fourth large language model configured to determine a set of suitable groupings for the responses from the third large language model component 304. If the grouping component 314 includes a fourth large language model, the grouping component can use an aggregation prompt to process the outputs of the third large language model component 304 and identify similar outputs (e.g., similar facts) to create groups of the outputs.

For example, if the user query is: “what are customers calling about”, the outputs of the third large language model component 304 can be extracted facts like “the customer called to cancel their account,” “cancel account,” “upgrade plan,” “asked to upgrade the plan.” An example output of the grouping could be “cancel account”, “upgrade plan.” If the user query was “suggest scripts to prevent churn” then the outputs of the third large language model component 304 can include suggestions, and the grouping can group together similar suggestions.

The classification component 316 can be used to classify the responses from the third large language model component 304 into the groups selected by the grouping component. Optionally, the classification component can include a semantic similarity component and/or a fifth large language model component. The semantic similarity component and/or fifth large language model component can be configured to receive the groupings from the grouping component 314 and the responses from the third large language model component 304 and determine the most appropriate grouping for each.

The post-processing component can further include a grounding component 318. The grounding component 318 can be used to “ground” the LLM responses described herein in the ground-truth data (the preprocessed content 103). Because LLM’s predict tokens, LLM’s can fail to accurately reproduce precise text. Instead, the LLM response may be close to the truth, or similar to the truth, or fail to include the truth at all. These phenomena are colloquially referred to as “hallucinations” or “lying.” These phenomena limit the ability of LLMs to perform accurate data analysis. Implementations of the present disclosure can overcome these problems by implementing the grounding component as a semantic match component.

The grounding component 318 can receive an LLM response (e.g., “the customer is calling because the order was three days late”) and search for semantically similar text in the preprocessed content 103. For example, the semantically similar text in the preprocessed content 103 may be “the order was two days late.” Thus, the grounding component 318 can be used to “ground” the LLM output in the preprocessed content 103 by finding the actual text in the preprocessed content 103 that corresponds to the LLM output (three days in the output vs. two days in the actual preprocessed content 103).

As another example, the grounding component can be configured to extract quotes from the LLM response and identify any exact matches to the quotes from the LLM response in the preprocessed content 103. If found, the exact matches are used to ground the LLM response. For quotes from the LLM response that are not exact matches to the preprocessed content, the grounding component 318 can apply fuzzy match processing. Fuzzy match processing can include segmenting the preprocessed content 103 into windows that are similar in length to the quotes (e.g., plus or minus two words). The grounding component 318 can apply a distance algorithm (e.g., Levenshtein, Gestalt, or any other matching algorithm) to the windows to identify similar strings by generating a similarity score. If the similarity score for a window is greater than a threshold (e.g., .8 on a 0 to 1 point scale), then the text in the window can be used by the grounding component 318 to ground the response. If no window yields a similarity score greater than the threshold, then the grounding component 318 can remove the quoted text from the LLM response.

A formatting component 320 can be used to format the outputs of the third large language model component 304 and/or any outputs of the post-processing component 306 (e.g., outputs of the grouping component 314, classification component 316, and/or grounding component 318). Optionally, the formatting component can be configured to select subsets of the outputs (e.g., portions of longer quotes) to simplify the outputs.

For example formatting component 320 can be used to post-process the output by combining the output(s) from the third large language model component 304 with the semantically similar “ground truth” found in preprocessed content 103 by the grounding component 318. Optionally, the formatting component 320 can replace incorrect large language model outputs identified by the grounding component 318 with the ground-truth results from the preprocessed content 103. Alternatively or additionally, the formatting component 320 can format ground truth results of the grounding component 318 as citations, links, cross references, or any other format that allows a user to compare the LLM output to the ground-truth identified by the grounding component 318.

Alternatively or additionally, the formatting component 320 can be configured to structure any of the data described herein as graphs, charts, images, formatted text documents, and/or multimedia (e.g., original call audio synched with text from the preprocessed content 103). The formatted outputs can be output as response data 120. For example, if the query is “Why do customers call?”, then the response data 120 may include “24% of the customers asked about billing issues; 15% called to reset their password.”

As yet another example, the formatting component 320 can be configured to structure any of the data described herein using a predefined schema. For example, the formatting component 320 can structure the response data in a predefined JSON format.

And, as yet another example, the formatting component 320 can optionally include another large language model component (e.g., a sixth large language model). The sixth large language model can be configured to generate a summary of the response data 120 that can be output with the response data for display to the user.

FIG. 3B illustrates an example open-ended analysis component 214. The open-ended analysis component 214 can be implemented using a second large language model component 302, a third large language model component 304, and a post-processing component 306 described with reference to FIG. 3A.

The open-ended analysis component 214 can be configured to implement an open-ended workflow. As used herein, an “open ended” workflow is a workflow that does not have a predetermined output (e.g., counting, statistics, etc.) An example of an open-ended workflow is a workflow configured to cause the large language model to output suggestions or ideas in natural language in response to each input. The suggestions or ideas can optionally be grouped by a grouping component 314. As described with reference to FIG. 3A, the grouping component 314 can be configured as another large language model component and/or as a semantic similarity component. Optionally, the pre-processing component 306 of FIG. 3B can include a formatting component 320 (not shown) as described with reference to FIG. 3A. The open-ended analysis component 214 can be used as a “creative” workflow, because a user can use the open-ended responses as the basis for creating new workflows, and/or learn about the content 102 (e.g., to improve the system that creates the content 102). For example, the response data 120 output by the open-ended analysis component 214 may include an improved script for text interactions and/or suggestions for data analysis queries that can be used on the preprocessed content 103.

FIG. 3C illustrates an example counting analysis component 216. The counting analysis component can be implemented using a second large language model component 302, a third large language model component 304, and a post-processing component 306 described with reference to FIG. 3A.

The counting analysis component 216 can be configured to implement a “counting” workflow where the number of instances of an event in the preprocessed content 103 are counted. The second large language model component 302 can be configured with a binary prompt generation component 350, which configures the second large language model component 302 to output a prompt configured to generate binary (e.g., yes or no) responses to the preprocessed content 103. For example, the counting workflow can be used to count how many times a customer complains about a late delivery by creating a prompt that instructs the third large language model component 304 to determine whether each text interaction in the preprocessed content includes a complaint about late delivery. The third large language model component 304 can then be invoked on each text interaction to generate a set of binary outputs for the text interactions in the preprocessed content.

The binary outputs of the third large language model component 304 can then be input into the post-processing component 306. In the example of FIG. 3C, the post-processing component 306 can include a counting component 322 that is configured to sum the binary responses and determine a number of binary responses that fall into either category (e.g., yes or no). The post-processing component 306 can further include a grounding component 318, as described with reference to FIG. 3A. For example, the grounding component 318 can extract the sections of text interactions in the preprocessed content 103 that are similar to binary responses to ground the binary responses in the preprocessed content 103. The grounded binary responses can then be formatted and output as response data 120 by the formatting component 320.

Optionally, the workflow components 210 described herein can be run any number of times using the same LLM or different LLMs to produce repeated outputs. For example, the workflow components 210 can be executed repeatedly with the same inputs. The post-processing component 306 can be configured to combine the repeated outputs into a single output, for example by applying majority voting. Alternatively or additionally, post-processing can include assigning a confidence score to the output of any LLM and repeating the workflow with a larger LLM (e.g., changing the LLM used in the third large language model component 304) when the confidence score is a below a threshold.

FIG. 3D illustrates an example indexing analysis component 218. The indexing analysis component 218 can be implemented using a second large language model component 302, a third large language model component 304, and a post-processing component 306 as described with reference to FIG. 3A.

The indexing analysis component 218 can be configured to implement an indexing workflow. An indexing workflow can be configured to find data in the preprocessed content 103 that are responsive to the query 104. For example, a user may input “provide the interaction IDs for the call concerning billing.”

The indexing analysis component 218 can include the binary prompt generation component 350 described with reference to FIG. 3C. The binary prompt generation component 350 can be configured to find the text interactions in the preprocessed content 103 that correspond to the user query (e.g., only text interactions transcribed from calls related to billing). The third large language model component 304 can output the results (e.g., only the calls related to billing) to an indexing component 324 configured to find the indices in each text interaction that relate to the query 104. The indexing component 324 can optionally be implemented as another large language model component and/or as a semantic similarity component. The outputs of the indexing component can be input into a grounding component 318 configured to ground the results in the preprocessed content 103, as described with reference to FIG. 3A. As also described with reference to FIG. 3A, the formatting component 320 can then output the indexed and grounded responses as response data 120 for display to a user.

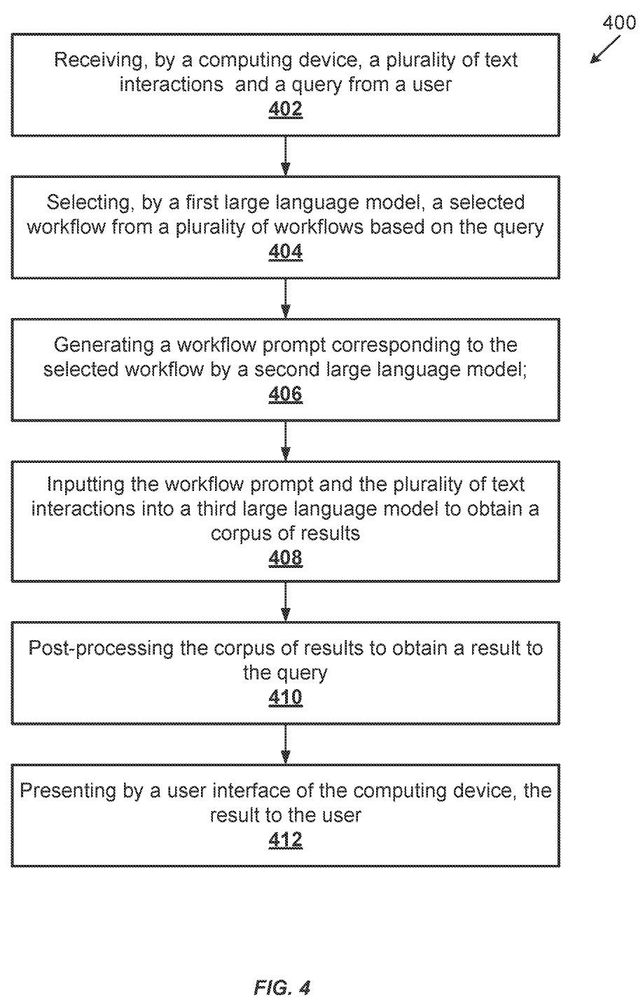

With reference to FIG. 4, implementations of the present disclosure include a computer-implemented method 400. Optionally, the computer-implemented methods described herein can be implemented using the systems described with reference to FIGS. 1-3D.

At step 402, the method includes receiving, by a computing device, a plurality of text interactions and a query from a user.

At step 404, the method includes selecting, by a first large language model, a selected workflow from a plurality of workflows based on the query.

As described above in greater detail with reference to FIGS. 3A-3D, example workflows include counting workflows, statistical analysis workflows, indexing workflows, and open-ended workflows. The counting workflow can use the third large language model to determine the presence or absence of a feature in each of the text interactions based on the query. The statistical analysis workflow can include aggregation and classification of features in the text interactions based on the query. The indexing workflow can include locating data within the text interactions based on the query. And, the open-ended workflow can be used to generate open-ended responses analyzing the text interaction based on the query.

Optionally the method can include not using the first large language model to select a workflow when the query is a predefined query that is mapped to a certain workflow optimized for that query. For example, the query “Suggest interesting questions to ask on the data” may be mapped to a specific latency-optimized workflow which returns quickly an answer, instead of being input into one of the other workflows described herein.

At step 406, the method includes generating, by a second large language model, a workflow prompt corresponding to the selected workflow.

At step 408, the method includes inputting the workflow prompt and the plurality of text interactions into a third large language model to obtain a corpus of results. Optionally, the plurality of text interactions are separated into subsets of text interactions before each subset of the text interactions is input into the third large language model. For example, each text interaction can be separately input into the third large language model with the prompt.

Optionally, more than one instance of the third large language model can be used, so that the plurality of text interactions can be input into the third large language model in parallel and/or in series. Optionally, the third large language model can be a smaller model than the second large language model and/or the first large language model. As described throughout the present disclosure, the use of a smaller model for the third large language model can increase the efficiency and speed of the method because the smaller model can be faster and/or require less resources to run than larger models.

At step 410, the method includes post-processing the corpus of results to obtain a result to the query.

At step 412, the method includes presenting, by the computing device, the result to the user.

Optionally, the method can include caching queries and responses from the user. For example, step 412 can include caching both the user query and corresponding result. The cached queries and responses can be indexed using embeddings. Non-limiting examples of embeddings include contextual embeddings (e.g., SBERT) and/or term-based embeddings (e.g., Bag-of-Words). In embodiments of the present disclosure including caching, step 404 can include comparing the query to the cached queries by similarity functions (e.g. cosine for SBERT and/or BM25 for Bag-of-Words). Different types of embeddings can be used simultaneously (e.g. BM25 for preliminary retrieval, and SBERT for advanced reranking). If the query is similar (e.g., above a determined threshold) to a cached query, the method can include retrieving the cached result and not executing one of the workflows. Embodiments including caching can therefore improve consistency a reduce cost/latency by avoiding repeat queries.

Alternatively or additionally, the method can include using the cached responses to determine if a query was already answered, regardless of whether the cached query is similar to the query. For example, if the cached query is “why are customers calling” and the response is “35% called because their router is not working” then the response both includes answers to the cached query and a subsequent query that asks “what percentage called because their router was not working?”. Thus implementations of the present disclosure can increase the efficiency of systems using large language models by using caching of queries and responses to minimize repeated LLM inputs and/or outputs.

A large language model can optionally be used to determine whether the cached query and response are relevant to the new query. Alternatively or additionally, a large language model can be used to determine if a query and response should be cached. Some queries may be generic (e.g., “Provide another example”) and therefore the query and associated response may not be cached.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

FIG. 5 illustrates examples of a computing system 500 that may include the kinds of software programs, data stores, and hardware that can implement systems and methods described herein. In some embodiments of the present disclosure, multiple computing systems according to FIG. 5 are used coupled by network interfaces.

As shown, the computing system 500 includes, without limitation, a central processing unit (CPU) 505, a network interface 515, a memory 520, and storage 530, each connected to a bus 517. The computing system 500 may also include an I/O device interface 510 connecting I/O devices 512 (e.g., keyboard, display and mouse devices) to the computing system 500. Further, the computing elements shown in computing system 500 may correspond to a physical computing system (e.g., a system in a data center) or may be a virtual computing instance executing within a computing cloud.

The CPU 505 retrieves and executes programming instructions stored in the memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of a random access memory. The storage 530 may be a disk drive or flash storage device. Although shown as a single unit, the storage 530 may be a combination of fixed and/or removable storage devices, such as fixed disc drives, removable memory cards, optical storage, network attached storage (NAS), or a storage area-network (SAN).

Illustratively, the memory 520 includes preprocessing component 521, an augmentation component 522, a tool component 523, one or more workflow components 524, a semantic routing component 525 and one or more large language model components 526, all of which are discussed in greater detail above. Further, storage 530 includes content 531, preprocessed content 532, response data 533, queries 534, cached queries and responses 535, LLM Model(s) 536, Prompts 537 and schemas 538, all of which are also described in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving, by a computing device, a plurality of text interactions and a query from a user;
selecting, by a first large language model, a selected workflow from a plurality of workflows based on the query;
generating, by a second large language model a workflow prompt corresponding to the selected workflow;
inputting the workflow prompt and the plurality of text interactions into a third large language model to obtain a corpus of results;
post-processing the corpus of results to obtain a result to the query; and
presenting, by the computing device, the result to the user.

2. The method of claim 1 wherein each text interaction of the plurality of text interactions is separately input into the third large language model.

3. The method of claim 2, wherein the plurality of text interactions are input into the third large language model in parallel.

4. The method of claim 1, wherein the third large language model is a smaller model than the first large language model or the second language model.

5. The method of claim 1, wherein the selected workflow comprises a counting workflow, and wherein the third large language model is configured to determine a presence or absence of a feature selected by the query in each of the plurality of text interactions.

6. The method of claim 1, wherein the selected workflow comprises an aggregation and statistical analysis workflow, and wherein the aggregation and statistical analysis workflow comprises aggregating the corpus of results to a smaller number of representative results by a fourth large language model, and classifying each of the plurality of text interactions to output a plurality of relevant results based on the query by a fifth large language model or by an embedding model.

7. The method of claim 1, wherein the selected workflow comprises an indexing workflow, and wherein the third large language model is configured to determine a feature of each of the plurality of text interactions based on the query.

8. The method of claim 1, wherein post-processing the corpus of results comprises applying a classifier to the corpus of results or augmenting the corpus of results with grounding data.

9. The method of claim 8, further comprising generating grounding data by pattern matching a quote from the plurality of text with the corpus of results.

10. The method of claim 1, further comprising:
receiving, by a computing device, a query history, wherein the query history comprises a plurality of queries and a plurality of responses corresponding to the plurality of queries; and
determining by the first large language model, that the query matches one of the plurality of queries; and
outputting the corresponding response from the plurality of responses.

11. The method of claim 1, wherein the selected workflow comprises an open-ended workflow, and wherein the third large language model is configured to provide open-ended based on each of the plurality of text interactions based on the query.

12. A system comprising:
a computing device; and
a computer-readable medium with computer-executable instructions stored thereon that when executed by the computing device cause the computing device to:
receive, by a computing device, a plurality of text interactions and a query from a user;
select, by a first large language model, a selected workflow from a plurality of workflows based on the query
generate, by a second large language model a workflow prompt corresponding to the selected workflow;
input the workflow prompt and the plurality of text interactions into a third large language model to obtain a corpus of results;
post-process the corpus of results to obtain a result to the query; and
present, by a user interface of the computing device, the result to the user.

13. The system of claim 12, further comprising computer-executable instructions that when executed by the computing device cause the computing device to: separately input each text interaction of the plurality of text interactions into the third large language model.

14. The system of claim 12, further comprising computer-executable instructions that when executed by the computing device cause the computing device to: input the plurality of text interactions into the third large language model in parallel.

15. The system of claim 12, wherein the third large language model is a smaller model than the first large language model or the second language model.

16. The system of claim 12, wherein the selected workflow comprises a counting workflow, and wherein the third large language model is configured to determine a presence or absence of a feature selected by the query in each of the plurality of text interactions.

17. The system of claim 12, wherein the selected workflow comprises a statistical analysis workflow, and wherein the third large language model is configured to classify each of the plurality of text interactions based on the query.

18. The system of claim 12, wherein the selected workflow comprises an indexing workflow, and wherein the third large language model is configured to determine a feature of each of the plurality of text interactions based on the query.

19. The system of claim 12, further comprising computer-executable instructions that when executed by the computing device cause the computing device to: augment the corpus of results with grounding data or apply a classifier to the corpus of results..

20. The system of claim 19, further comprising computer-executable instructions that when executed by the computing device cause the computing device to: generate the grounding data by pattern matching a quote from the plurality of text with the corpus of results.
